(19) United States
(12) Patent Application Publication
(10) Pub. No.: US 2020/0274208 A1
(43) Pub. Date: Aug. 27, 2020

(54) Battery element having a thermal conduction element

(71) Applicant: Erbslöh Aluminium GmbH, Velbert (DE)

(72) Inventors: Norbert William Sucke, Duisburg (DE); Lothar Löchte, Hilden (DE); Andreas Becker, Remscheid (DE); Marcel Götz, Wuppertal (DE)

(21) Appl. No.: 15/733,041

(22) PCT Filed: Dec. 12, 2018
(86) PCT No.: PCT/EP2018/084528

§ 371 Date: Apr. 27, 2020

(30) Foreign Application Priority Data
Dec. 15, 2017 (DE) 10 2017 130 068.6

(51) Int. Cl. H01M 10/613; H01M 10/647; H01M 10/655; H01M 10/653; H01M 2/26; H01M 2/02; H01M 2/04

(52) U.S. Cl. CPC H01M 10/613; H01M 10/647; H01M 10/655; H01M 2/0426; H01M 2/263; H01M 2/0275; H01M 10/653

(57) ABSTRACT

The invention relates to a new battery element (10), in which a thermal conduction element in the form of a multi-chamber hollow profiled element (20) having chambers (21) is integrated in addition to a battery cell. The heat transfer is optimal, because the temperature-controlled multi-chamber hollow profiled element (20) is in planar contact with the battery cell. The electrodes (31) of the battery element (10) are surrounded by an outer electrical insulation, which is formed solely by an outer film (40, 40) or by said film (40, 40′) and a thermoplastic plastic coating (27) of the multi-chamber hollow profiled element (20).

The invention relates to a battery element having at least one electrode stack, which is surrounded by an outer, electrical insulation and having at least one heat-conducting element.

Battery cells, in particular lithium-ion cells, are known, which, owing to their high energy density and their low weight, are regarded as advantageous cell types for use in motor vehicles. Such battery cells comprise stacked or folded electrochemically active layers which are separated from one another by nonwoven plastic separators in order to prevent short circuits.

Said electrode stacks are enclosed by a flexible outer film. This outer film is closed except for one edge and the film bag thus formed is filled with an organic electrolyte. The film bag is then closed and sealed, wherein contact tabs protrude from the film bag as connections of the electrodes. These battery cells do not have a rigid outer envelope, which makes them flexible but also sensitive to mechanical stresses.

From the German document DE 10 201 0 055 599 A1, it is known to clamp the flexible battery cells between two adjacent frames and to combine a plurality of such framed battery cells to form a battery module. Cooling plates are provided on the upper side of the battery module, said plates being in heat-conducting contact with the individual battery cells, namely with the end face thereof. When such battery cells are charged, in particular during rapid charging, heating occurs, as a result of which the electrolyte is heated and an excess pressure is produced in the battery cell. In the event of overheating, the electrolyte can evaporate and the battery cell can be destroyed. In the above-mentioned frames, oval openings for the pressure reduction in such short circuits are provided, so that the electrolyte vapor can escape. It is desirable to prevent such overheating.

The document DE 10 201 1 002 666 A1 describes the cooling of a pouch cell in an energy storage device. Here, during assembly, the each pouch cell is brought into heat-conducting contact with one cooling element on two opposite lateral surfaces. The heat generated in the pouch cell is transferred to the cooling elements by heat conduction and is then dissipated by a cooling fluid which flows through at least one flow channel of the respective cooling elements. The cooling elements are fastened to a carrier plate of the energy storage device at a predetermined distance by means of sliding shoes. Good heat dissipation is only achieved if the pouch cell is in contact with the two cooling bodies over a large area on both sides. Manufacturing tolerances can, however, result in air gaps being formed between the cooling elements and the pouch cell, said air gaps impairing the heat dissipation. The cooling elements shown are relatively thick and thus also have an undesirably high weight.

The document DE 10 201 1 107 716 A1 shows better cooling. A battery element is shown here, which has an insulation element on one side surface and a cooling element on the other side. The cooling element consists of two metal sheets with a polymer coating. A web structure, which can consist of aluminum or a polymer, is arranged between the metal sheets. In order to obtain a one-piece battery element having an integrated cooling element, the cooling element is flattened at its ends or is connected to the insulation element by means of an additional insulation body to form a jacket of the main body of the battery cell. The plurality of cooling passages ensures the dissipation of the heat generated in the battery cell. The multi-layer construction of the cooling element is disadvantageous.

The aim of the invention is to provide an improved battery element with more efficient cooling. The battery element is intended to be used in particular for battery modules of motor vehicles and should have as low a weight as possible for this purpose.

This object is achieved by a battery element having the features of claim 1. The dependent claims describe advantageous embodiments. The new battery element represents an improvement of the known pouch cell. In addition to one or more battery cells, in particular lithium-ion cells, a heat-conducting element in the form of one or more multi-chamber hollow profiles is also integrated in the battery element. This multi-chamber hollow profile serving for cooling or optionally also the heating of the battery cell is of flat design, has two opposite broad sides and, in the interior, a plurality of chambers which are arranged adjacent to one another and run parallel through the multi-chamber hollow profile. A temperature-control medium flows through the chambers, for example for cooling a cooling liquid, a coolant or gaseous media, such as, for example, air in order to transport away the heat generated in the battery cell. A cooling of the battery cell is described below. Even if the multi-chamber hollow profile can also serve to heat the battery cell, the heat transport is optimal, since a wide side surface of the multi-chamber hollow profile is in planar contact with the side surface of at least one insulated electrode stack of a battery cell. For the sake of simplicity, the term electrode stack is subsequently used for the inner components of the battery cell, namely the two electrodes with the separators and the electrolyte. The two electrodes can be flat or can be folded several times.

For example, an electrode stack is located on the upper side and a further electrode stack lies flat against the underside of the multi-chamber hollow profile. In this case, the multi-chamber hollow profile is integrated centrally between the two electrode stacks in the battery element.

In an advantageous embodiment, a side wall of the multi-chamber hollow profile forms a wall of the battery cell, i.e. the multi-chamber hollow profile and an outer sealable film together enclose an electrode stack with the separators and the electrolyte. The multi-chamber hollow profile has an electrically insulating plastic coating for the connection to the sealable film. Owing to this electrically insulating plastic coating, the multi-chamber hollow profile is, on the one hand, electrically insulated with respect to the electrode stack and, on the other hand, this coating, consisting of thermoplastic plastics, on the outer surface of the multi-chamber hollow profile allows a connection to the sealable film covering the electrode stack in the provided connection regions. For such a connection of the film to the multi-chamber hollow profile, the latter is preferably of such a width that connecting regions can be provided on the longitudinal edges of the multi-chamber hollow profile. Since the longitudinal edges of the multi-chamber hollow profile are loaded by pressure forces and heat during such a sealing operation, no chambers are provided at these longitudinal edges in an advantageous embodiment such that, in the event of a connection of the sealable outer film to the longitudinal edges of the multi-chamber hollow profile, stability losses on the multi-chamber hollow profile do not occur despite a heat input and mechanical loads.

In a further embodiment, the electrode stack, as in a known pouch cell, is completely surrounded by an outer, electrically insulating, sealable film. In this new battery element, the multi-chamber hollow profile together with one or more known battery cells then form a unit, i.e. an integral component. In the simplest embodiment, the battery cell is pressed against the multi-chamber hollow profile and mechanically clamped thereto. Examples of such elastic tensioning elements are a film or a fabric. In a further embodiment, at least one known battery cell, i.e. an electrode stack having an outer, electrically insulating, sealable film, is arranged adjacent to the wide side surfaces of the multi-chamber hollow profile and is surrounded by a further outer film and is thereby pressed against the multi-chamber hollow profile and held flat against the multi-chamber hollow profile. Such an additional outer film can, for example, also be drawn in the form of a tube via such an arrangement, namely the battery cells and the multi-chamber hollow profile arranged therebetween, the ends of the tube being connected to the coated multi-chamber profile. The invention further relates to a winding comprising a film.

In a further embodiment, the battery cell is connected to the multi-chamber hollow profile via the outer, sealable film thereof. For this purpose, the multi-chamber hollow profile has the electrically insulating, thermoplastic coating. Said plastic coating of the multi-chamber hollow profile and the sealable film of the battery cell are connected to each other in order to form the new battery element. The cohesive connection is produced by welding or sealing the thermoplastic material of the multi-chamber hollow profile with the thermoplastic material of the outer film of the battery cell is obtained.

In a further embodiment, a connection between the film of the battery cell and the multi-chamber hollow profile is achieved in that a sealable intermediate film is arranged between the two. This intermediate film is connected to the multi-chamber hollow profile and, in desired connecting regions, forms a cohesive connection to the film of the battery cell.

A simple connection possibility between the multi-chamber hollow profile and the outer film of the battery cell is also an adhesive connection. The surface of the multi-chamber hollow profile is pretreated for good adhesion to the multi-chamber hollow profile. Such a pretreatment consists, for example, of a plasma treatment, a fibre treatment, an anodization, a mechanical surface treatment or special coatings in order to improve the adhesion of the surface of the multi-chamber hollow profile. Conversion layers or galvanization of the outer surfaces of the multi-chamber hollow profile produced by arc welding can be used as coatings. In the case of a large-area adhesive connection between the outer film of the battery cell and the multi-chamber hollow profile, it is to be taken into account that the battery cell expands due to the development of heat during charging and discharging. This is to be taken into account by providing an expansion joint. Thus, for example, an adhesive-free region is provided between the battery cell and the multi-chamber hollow profile, preferably this region is arranged in the transverse direction of the multi-chamber hollow profile.

In the above-described manner, at least one electrode stack is connected to a lateral surface of the multi-chamber hollow profile. Said electrode stacks are each covered by an outer sealable film or surrounded by an outer film. In this way, the multi-chamber hollow profile is an integral component of the new battery element, wherein the electrode stacks arranged on one side or on both sides rest on the multi-chamber hollow profile over a large area.

In this case, it is also possible for a plurality of electrode stacks or battery cells arranged next to one another to be connected to the upper side and/or lower side of the multi-chamber hollow profile. In the case of an arrangement of a plurality of electrode stacks or a plurality of battery cells both on the upper side and on the underside of the multi-chamber hollow profile, these can be arranged opposite one another or else offset with respect to one another. Furthermore, it is also possible to fasten the electrode stacks, which are arranged on the underside of the first multi-chamber profile, with their opposite broad side to a further multi-chamber hollow profile, with the result that a battery element is produced from five layers arranged one above the other, namely electrode stack, multi-chamber hollow profile, electrode stack, multi-chamber hollow profile, electrode stack.

In a further embodiment, a connection between the battery cell and the multi-chamber hollow profile is achieved by wrapping. Here, the battery cell is very flat, and has flat elongate electrodes which are separated by separators and are surrounded by a film bag. This flat battery cell has a comparatively large bag length starting from one end, at which the contact tabs extend out of the film bag to the other end, the bag bottom. This long bag-like battery cell is wound around the multi-chamber hollow profile and held on the multi-chamber hollow profile.

In an advantageous manner, a multi-chamber hollow profile is provided as an integral component of the battery cell for controlling the temperature of the battery cell. The multi-chamber hollow profile serves, on the one hand, for heating or, on the other hand, to heat away the heat produced in the battery element and, for this purpose, flows through a cooling medium. Said multi-chamber hollow profile is preferably an extruded profile made of aluminum or an aluminum alloy. This material has, on the one hand, good heat conduction properties and can furthermore be produced in an advantageous manner as an extruded profile at a very low height. The height H of the multi-chamber hollow profile is 0.3 mm to 10 mm, preferably 0.8 to 3 mm. Thus, a battery element of low construction height and low weight can be produced. If, for example, two electrode stacks each having a height H_{B} of approximately only 8 mm and a multi-chamber hollow profile having a height H of 3 mm are used for a battery element, such a battery element having an integrated heat-conducting element has a construction height of less than 20 mm. The length of the battery element, ie the length of the multi-chamber hollow profile, can be selected as desired for the purpose of application. The width of the battery element is preferably provided in such widths which can be optimally extruded, for example up to a width of 200 mm.

Alternatively, the multi-chamber hollow profile can also be made of sheet metal, for example made of a folded sheet metal or by a roll-bond-process.

In all the aforementioned embodiments, the electrode stacks are in surface contact with the multi-chamber hollow profile, that is the heat transport during rapid charging of such a battery cell takes place over the shortest path from the electrochemically active layer of the electrode stack arranged furthest away in the battery cell to the surface of the multi-chamber hollow profile. This advantage of the new battery element is expressed in a geometry factor G, namely

G=H_{B}/H

the ratio of the body height of the battery cell H_{B} to the height H of the multi-chamber hollow profile. In the case of the new battery elements, this geometry factor G is between values of 1.3 and at most 25, preferably between 3 and 7. These values illustrate that the entire electrode stack is well tempered, namely in particular also the electrochemically active layer of the electrode stack in the battery cell arranged furthest away from the multi-chamber hollow profile.

The heat is conducted out of the battery element via the chambers of the multi-chamber hollow profile through which cooling medium flows. For this purpose, the chambers on the end faces of the multi-chamber hollow profile are connected to a cooling system or a collector via connections. In the case of very long battery elements, in particular in the case of a plurality of battery cells provided in the longitudinal direction of the multi-chamber hollow profile, the cooling medium flows through the multi-chamber hollow profile, for example in a w-shape or z-shape. The connections are only arranged on one end face of the multi-chamber hollow profile. This has the advantage that the temperature differences of the cooling medium in the battery element are minimized.

The new battery element advantageously ensures a good thermal connection of the electrode stacks to the multi-chamber hollow profile, which can be expressed by a thermal characteristic number TK. This thermal characteristic number TK expresses how large the tempered area of the multi-chamber hollow profile is in relation to the contact area of the electrode stack on the multi-chamber hollow profile.

TK=ΣB_{K1-n}/(B_{E})

B_{E} is the width of the contact region of an electrode stack on the multi-chamber hollow profile. B_{K} is the width of a chamber of the multi-chamber hollow profile, which chamber is temperature-controlled by a fluid. The sum of all chamber widths is related to the width of the contact region. The new battery elements exhibit very good thermal characteristic numbers TK of greater than 0.8.

In each application described above, an outer sealable film is used. This can be a composite film, as is used for known battery cells. Such foils have a sealable, thermoplastic layer on one side, an intermediate layer in the form of an aluminum foil as a diffusion barrier and, in turn, a plastic layer on the outer side. The inner layer of these composite films consists in particular of thermoplastic material, such as polyolefins, preferably of polypropylene, which melts through the application of heat and can be connected to the surface of the multi-chamber hollow profile with an electrically insulating, thermoplastic plastic coating. This plastic coating on the multi-chamber hollow profile is also a sealable, i.e. heat-weldable plastic, such as polyester or polyolefins. Here too, for example polypropylene is used, which can be applied in the form of powder by a powder coating on the multi-chamber hollow profile. In addition, a wet paint coating is also possible or a plastic film is applied to the surface of the multi-chamber hollow profile, for example by film lamination. This thermoplastic synthetic coating is preferably provided over the entire surface on the surface of the multi-chamber hollow profile, in particular to ensure appropriate electrical insulation from the electrode stack and on the other hand to connect to the outer film along the longitudinal edges but also at any point across the width of the multi-chamber hollow profile, namely for extensive inclusion of an electrode stack. Only the contact lugs of the electrodes are led out of such a covering of the electrode stack. In addition, the end faces of the multi-chamber hollow profile can protrude beyond the foil-covered electrode stacks in order to connect the inner chambers more easily to corresponding connections for cooling or to collectors.

Advantageously, by means of the integrated cooling or heating in the form of the multi-chamber hollow profile, the battery element also provides its own stability and can be inserted in this stable form without a frame into a housing in order to form a battery module, wherein the weight advantage over known battery elements with framed battery cells is not lost due to the thin and light multi-chamber hollow profile.

Furthermore, the electrode stacks or battery cells are fastened with their surface to the multi-chamber hollow profile in a potential-free manner at a very short distance, wherein the multi-chamber hollow profile is connected to the contact surfaces in order to form an electrode stack in the battery element by means of a plastic insulation, for example. It is electrically insulated by means of a plastic coating.

The drawing shows an exemplary embodiment. The invention is not limited to this exemplary embodiment. In this drawing:

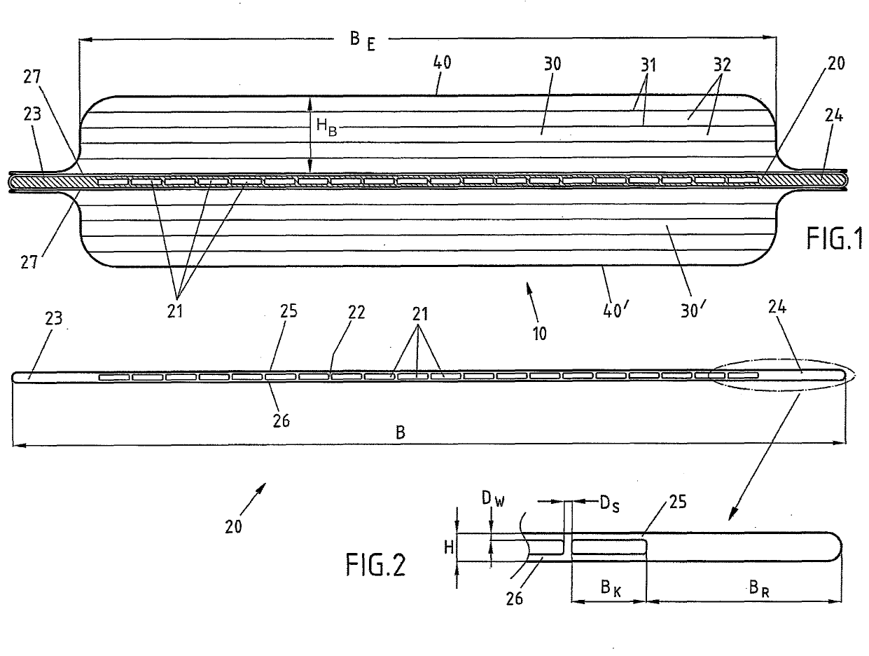

FIG. 1 shows a cross-section through a new battery element,

FIG. 2 shows a cross-section through the multi-chamber hollow profile,

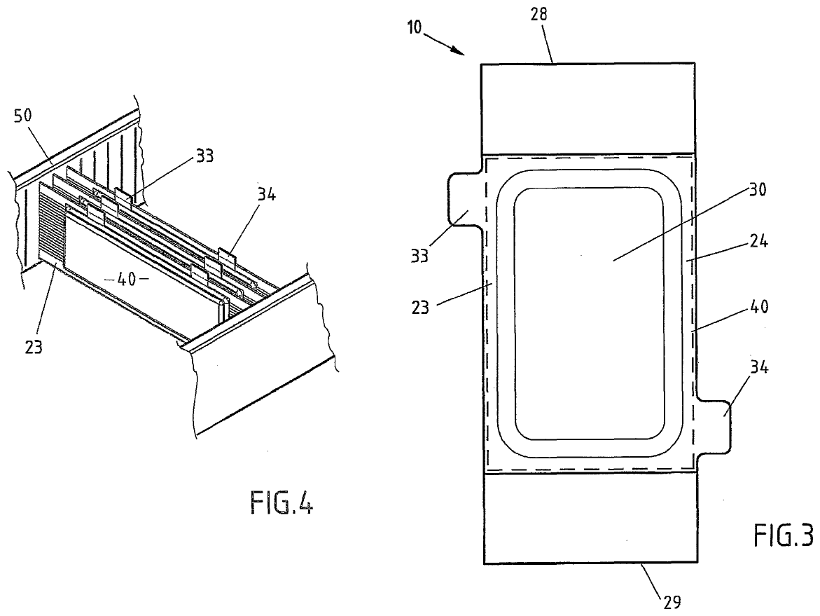

FIG. 3 is a top view of the battery element according to FIG. 1,

FIG. 4 is a perspective view of a portion of one battery module with battery elements,

FIG. 5 is a top view of FIG. 4,

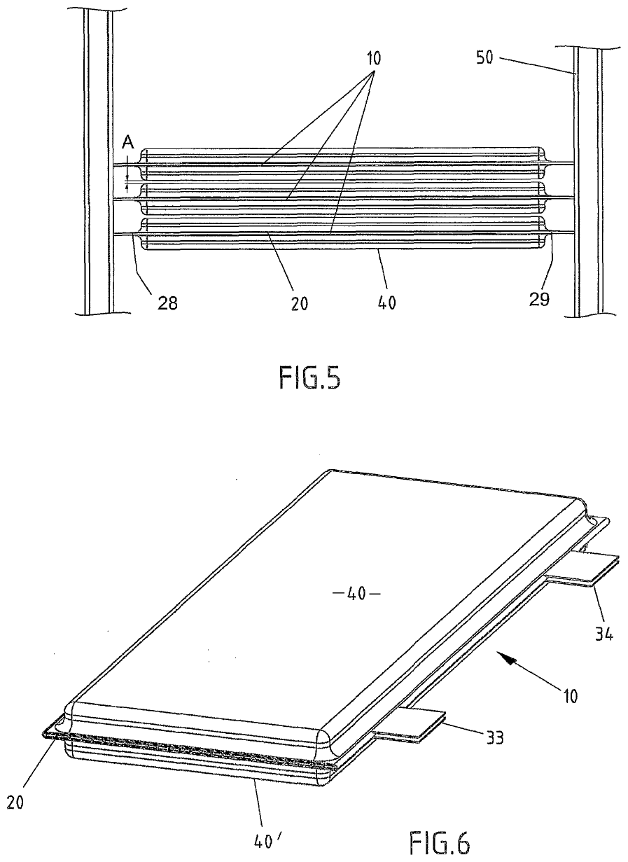

FIG. 6 is a perspective view of another battery element,

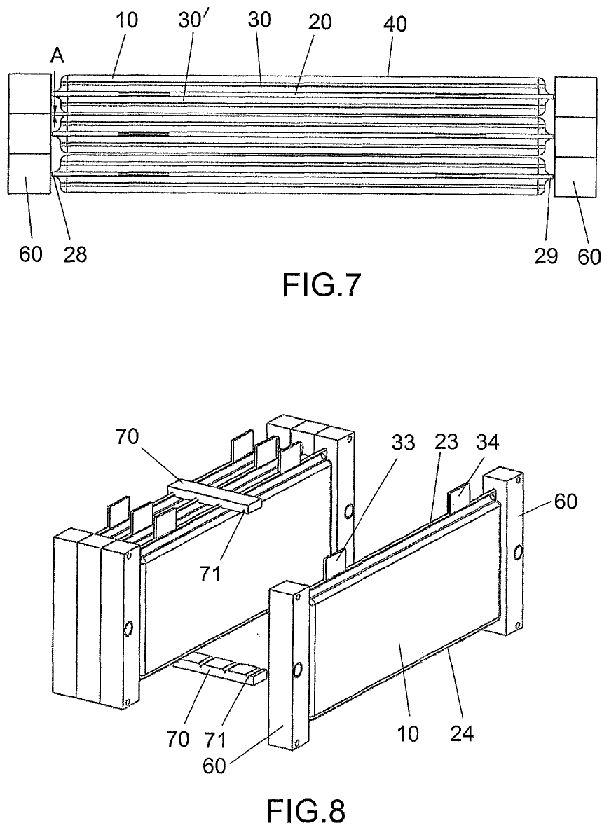

FIG. 7 is a top view of a portion of another battery module with battery elements,

FIG. 8 is a perspective view of a part of a battery module with battery elements of FIG. 7,

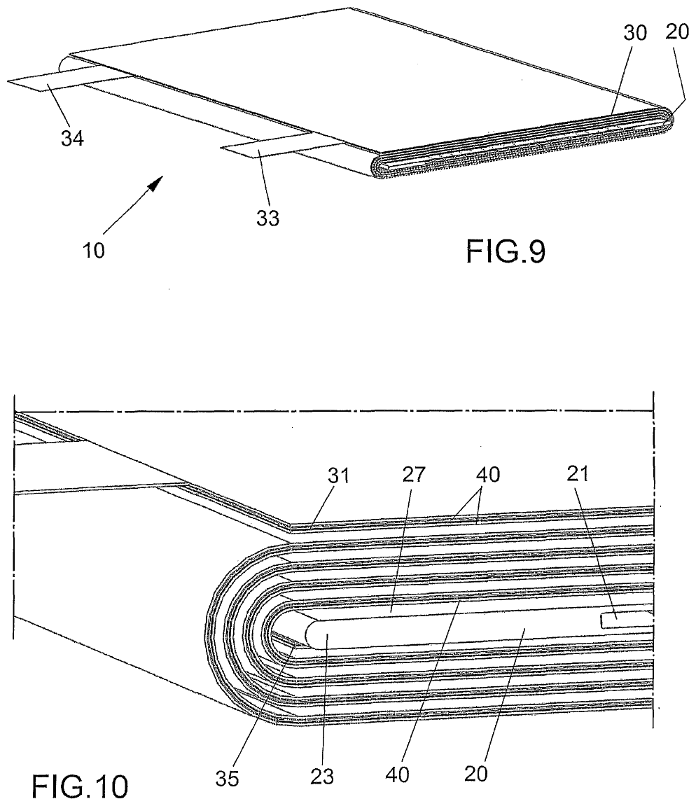

FIG. 9 is a perspective view of another battery element and

FIG. 10 is an enlarged detail of FIG. 9.

In the figures, the same reference numerals are used for identical components in the different embodiments.

The new battery element 10 shown in FIG. 1 comprises two electrode stacks 30, 30′ which are arranged on both sides of a heat-conducting element provided for temperature control. The heat-conducting element is a flat multi-chamber hollow profile 20. The electrode stacks 30, 30′ are only indicated in an abstract manner. They comprise electrodes 31 which are folded as active layers together with an electrolyte and are separated from one another by separators 32. The electrode stacks 30, 30′ are surrounded on the outside by an outer sheath 40 or 40′. In comparison to a known pouch cell, where an electrode stack is likewise surrounded by an outer sleeve, the new battery element 10 comprises two electrode stacks and, as an integral component, additionally the centrally arranged multi-chamber hollow profile 20. This has a plurality of chambers 21 arranged next to one another and running parallel. On the broad outer side, the multi-chamber hollow profile 20 is provided with a plastic coating 27 over its entire surface. In this case, this plastic coating 27 is a polypropylene layer. This layer is so thick that the multi-chamber hollow profile 20 is electrically insulated from the electrode stacks 30, 30′. In the same way, the outer films 40, 40′ comprise an electrically insulating layer, so that the battery element 10 is electrically isolated from the outside. In this case, the outer films 40, 40′ are a three-layer composite film. The outer and inner layers consist of polypropylene. An aluminum foil is provided as a diffusion barrier between the polypropylene layers. The foils 40, 40′ are connected to the plastic coating 27 of the multi-chamber hollow profile 20 at the catching wheels 23, 24 of the multi-chamber hollow profile 20. The connection was achieved by pressing the edges of the films 40, 40′ against the catchment edges 23, 24 of the multi-chamber hollow profile 20, the polypropylene of the films 40, 40′ is welded to the polypropylene plastic coating 27.

In this case, two films 40, 40′ were used. It is also possible to use a single foil which surrounds the entire battery cell and, for example, is connected to the plastic coating 27 of the multi-chamber hollow profile 20 by foil edges at a trapping edge 23 of the multi-chamber hollow profile 20.

In addition, it is possible to use known battery cells, to arrange these on both sides of the multi-chamber hollow profile 20 and to enclose them with a polypropylene film as an outer layer and to connect them to the multi-chamber hollow profile 20 and thus to provide them with cooling. In this case, for example, for two battery cells, a common foil is provided, which is fastened only to a catchment edge 23 or one film tube can be drawn over the arrangement, which is connected at its end sides to the multi-chamber hollow profile 20 over the width of the multi-chamber hollow profile.

If known battery cells are provided on their outer side with a sealable foil, it is also possible to connect these battery cells to the multi-chamber hollow profile 20 via their outer envelope.

A cooling or heating in the form of a multi-chamber profile 20 is provided for such a new battery element 10. This multi-chamber profile 20 is shown once again in FIG. 2. It consists of an extruded profile of aluminum or an aluminum alloy which preferably has a height H of 0.3 to 5 mm when a cooling liquid and 0.5 mm to 10 mm are used when a gaseous refrigerant is used. In this case, the height is 1.5 mm. The chambers 21 produced in the extruded profile are separated by webs 22. These webs 22 provide sufficient stability to the multi-chamber hollow profile 20 and ensure that the multi-chamber hollow profile does not fall into the region of the chambers 21 after extrusion, since the wall thickness D_{W} in this case is 0.35 mm, as is the thickness of the webs D_{S}. The wall thicknesses D_{W} and thicknesses of the webs D_{S} of a multi-chamber hollow profile 20 are 0.08 mm to 2 mm, preferably 0, 15 mm to 0.5 mm, in this example 0.35 mm, so that a chamber height of 0.8 mm results. When using a gaseous refrigerant, wall thicknesses D_{W} and thicknesses of the webs D_{S} of a multi-chamber hollow profile are 0, 15 mm to 5 mm. In this example, the rectangular chambers 21 of the multi-chamber hollow profile 20 have a width B_{K} of 4.1 mm. In addition to the rectangular shape, the chambers 21 can also have a different shape. The chambers 21 are provided adjacent over a substantial region of the width of the multi-chamber hollow profile 20. For good heat dissipation, it is advantageous that a large volume flow of fluid flows through the multi-chamber hollow profile 20. This is ensured by a plurality of chambers 21.

As can be seen in FIG. 1, chambers 21 of the multi-chamber hollow profile 20 are arranged below or above the electrode stacks 30, 30′, so that the heat generated in the electrode stacks 30, 30′ is rapidly transported away via the planar planar contact with the multi-chamber profile 20, namely via the heat conduction of the aluminum profile and the heat transport by means of a medium flowing through the chambers 21, for example a coolant or coolants. The coolant used is, for example, water-glycol mixture. Gaseous media such as, for example carbon dioxide or fluorinated hydrocarbons are known. In an advantageous manner, the new battery element ensures a good thermal connection of the multi-chamber profile 20 to the electrode stacks 30, 30′, which is expressed by the thermal characteristic number TK. This thermal characteristic number TK

TK=ΣB_{K1-n}/(B_{E})

This results in a width BE of 87 mm in this example, namely the width of the contact zone of the electrode stacks 30, 30′ on the multi-chamber hollow profile 20, see FIG. 1. Each rectangular chamber 21 of the multi-chamber hollow profile 20 has a width B_{K} of 4.1 mm. The sum of all chamber widths results in 20×4.1 mm=82 mm. The thermal characteristic number T_{K} thus amounts to T_{K}=82/87=0.94. In this case, the diameter of the round chambers is used for the value B_{K}. In the case of differently shaped chambers, such as, for example, triangular chambers, the webs between the chambers can be inclined. In these cases, the projection of the chamber width onto the battery surface is used for the value B_{K}.

The advantage of the new battery element 10 is also expressed in the geometry factor G, which represents the ratio of the body height H_{B} of the battery cell to the height H of the multi-chamber hollow profile 20. The body height H_{B} of the battery cell is shown in FIG. 1 and represents the height of electrode stacks 30 including foil 40. The value H_{B} is 8 mm. The multi-chamber hollow profile 20 used has a height H of 1.5 mm. Thus, a geometric factor of G=8/1.5=5.3 is obtained. The same applies to the electrode stack 30′ on the underside of the multi-chamber hollow profile 20. The geometry factor G=5.3 and the thermal characteristic number TK=0.94 make it clear that the two electrode stacks 30 and 30′ are well tempered, namely in particular also the electrochemically active layer 31 of the electrode stacks 30, 30′ arranged furthest away from the multi-chamber hollow profile 20.

In the example of FIG. 1, no chambers 21 are provided on the multi-chamber hollow profile 20 in the region of the longitudinal wheels 23, 24. As a result, the thin multi-chamber hollow profile 20 has sufficient stability. To produce the new battery element 10, a multi-chamber hollow profile strand with a cross section, as shown in FIG. 2, is extruded. After extrusion, this multi-chamber hollow profile strand is completely coated with polypropylene and subsequently a desired length is separated from the extruded profile strand which serves as a multi-chamber hollow profile 20 for the battery element 10. On the top and bottom side 25, 26 of the multi-chamber hollow profile 20, the electrode stacks 30, 30′ are arranged and covered by an outer film 40, 40′, which is then connected at its longitudinal edges to the longitudinal wheels 23, 24 of the multi-chamber hollow profile 20 and, furthermore, at their front ends over the width of the multi-chamber hollow profile 20, as shown in FIG. 3 by the dashed line. The outer film 40, 40′ comprises the electrode stack 30, 30′ with all components, namely electrodes 31, separators 32 and electrolytes. Only the contact tabs 33, 34 project out of the outer film 40, 40′. In FIG. 3, by way of example, the contact lug 33 is arranged as a connection of the cathode on the longitudinal edge 23 and the contact lug 34 is arranged as a connection of the anode on the longitudinal edge 24. Depending on the design of the battery module in which the battery elements 10 are installed, the contact lugs 33, 34 can be led out of the outer film on the same longitudinal edge 23, 24 or on another side. In the example of FIG. 3, the multi-chamber hollow profile 20 projects with its end faces 28, 29 beyond the electrode stacks 30, 30′, so that the chambers 21 of the multi-chamber hollow profile 20 can be connected in a simple manner to corresponding connections 60 or collectors 50. In a particular embodiment, the battery element is soldered to the connections or collector tubes, in particular by brazing.

If required, a longitudinal edge 23, 24 can be connected to a thermocouple in order to monitor the development of heat in the battery element or a battery module.

As shown in particular in FIGS. 1 and 3, the new battery element 10 represents a very stable element with respect to a known battery cell. The stability is ensured by the integrated multi-chamber hollow profile 20 and, despite the low height H and the thus low weight of the additionally provided multi-chamber hollow profile 20, the easily handled and floating battery element 10 itself has only a small height of less than 20 mm.

A plurality of battery elements 10 can be assembled to form a battery module of corresponding size, for example can be used on edge, as shown in FIGS. 4 and 5 for a further embodiment of a battery element 10. The same reference numerals have been used for the same elements of the battery element 10. Between the battery elements 10 used, a distance A is maintained, which permits a thermal expansion of the electrochemically active layers of the electrode stacks 30, 30′ without touching adjacent battery elements 10, see FIG. 5. Here, the chambers 21 of the multi-chamber hollow profiles 20 are connected, for example, to collecting tubes 50, forming a flow path, which collect or convey the temperature control medium. In contrast to the battery element 10 of FIG. 3, in this case of FIG. 4, the contact tabs 33, 34 protrude from the outer film 40 on the same side and can be electrically connected in a simple manner.

FIG. 6 shows a further battery element 10 according to the invention having a multi-chamber hollow profile 20 as a heat-conducting element for controlling the temperature of electrode stacks 30, 30′, which are not shown here. Only the contact tabs 33, 34 are visible, which protrude from the battery element 10 on one side. The electrode stacks 30, 30′ lie flat on the top side and on the bottom side on the multi-chamber hollow profile 20 and are delimited and protected from the outside by the films 40 and 40′. The films 40, 40′ are connected to the plastic coating 27 of the multi-chamber hollow profile 20. In this example, chambers 21 are also arranged in the region of the catchment edges 23, 24. Pressing to form the connection has been achieved by a somewhat greater wall thickness of the multi-chamber hollow profile 20. In this case, too, the multi-chamber hollow profile 20 is an extruded aluminum profile. This battery element 10 has a thermal characteristic of greater than 0.8, namely 0.899.

FIG. 7 shows a battery module made of battery elements 10 according to the invention, each having a multi-chamber hollow profile 20 as a heat-conducting element for controlling the temperature of electrode stacks 30, 30′, which are held on the upper and lower sides of the multi-chamber hollow profile 20. A distance A is maintained between the battery elements 10 in the battery module, said distance permitting thermal expansion of the electrochemically active layers of the electrode stacks 30, 30′. In this case, the battery element 10 additionally comprises connections 60 on both end faces 28, 29 of the respective multi-chamber hollow profiles 20. The connections 60 are used for forwarding the temperature control medium flowing through the chambers 21 of the multi-chamber hollow profiles 20. A plurality of such battery elements 10 can be combined to form a battery module of the desired size, as shown in FIG. 8. In this case, spacers 70 are provided which are plugged on one or both sides and stabilize long battery modules. In the example shown, these spacers 70 are designed as beads and have grooves 71 on one side at regular intervals, into which grooves 71 the catchment edges 23, 24 of the multi-chamber hollow profiles 20 can engage. The necessary distance A can optionally also be established via such spacers 70.

FIGS. 9 and 10 show an embodiment of a new battery element 10, in which the multi-chamber hollow profile 20 is wound around by a battery cell. Here, the battery cell is very flat, has two flat elongate electrodes 31 which are separated by separators and are surrounded by a bag made of sealable foil 40. This flat battery cell has a comparatively large bag length starting from one end, at which the contact lugs 33, 34 extend out of the foil bag to the other end, the bag bottom 35. This long bag-like battery cell is wrapped around the multi-chamber hollow profile 20 and is preferably held on the multi-chamber hollow profile 20 via a fusion of the sealable foil 40 of the foil bag. This connection has been made here, on the one hand, in the region of the bag bottom 35 and here with the catch edge 23 of the multi-chamber hollow profile 20. On the other hand, two films 40 lying against one another are connected to one another in the region of the contact tabs 33, 34. The result is a battery element 10 with a wound electrode stack 30, in which a heat-conducting element in the form of the multi-chamber hollow profile 20 is integrated. This embodiment also shows a good thermal connection.

### LIST OF REFERENCE SIGNS

10 Battery element
20 Multi-chamber hollow profile
21 Chambers
22 Webs
23, 24 Longitudinal edge
25 Top side
26 Underside
27 Plastic coating
28, 29 End side
30, 30′ electrode stack
31 Electrodes
32 Separators
33, 34 contact lugs
35 Bag base
40, 40′ Outer film
50 Collecting tube
60 Connection
70 Spacer
71 Groove
A Distance of 10
B Width of 20
B_{E} width of 30, 30′
B_{K} width of 21
B_{R} width of 23, 24
D_{S} Thickness of 22
D_{W} wall thickness
H Height of 20
H_{B} Height battery cell

1. A frameless battery element (10) for insertion in the housing of a battery module,
with at least one electrode stack (30, 30′),
the respective electrode stack (30, 30′) being surrounded by external electrical insulation and this insulation comprising a flexible sealable film (40, 40′),
with a cooling or heating heat-conducting element in the form of one or more flat multi-chamber hollow profiles (20), the respective multi-chamber hollow profile (20) being integrated in the battery element (10),
the multi-chamber hollow profile (20) having a plurality of mutually adjacent, parallel chambers (21) inside,
characterized in that
a wide side surface of the multi-chamber hollow profile (20) is in flat contact with the side surface of at least one insulated electrode stack (30, 30′) and the respective insulated electrode stack (30, 30′) is connected to the multi-chamber hollow profile (20); and
the respective electrode stack (30, 30′) is completely surrounded by the outer sealable film (40, 40′) or the outer, electrically insulating, sealable film (40, 40′), the multi-chamber hollow profile (20) and the respective electrode stack (30, 30′) thereby enveloped.

2. The battery element according to claim 1, characterized in that the respective electrode stack (30, 30′) with its insulated upper side or its insulated lower surface rests flat against the broad side of the multi-chamber hollow profile (20).

3. The battery element according to claim 1, characterized in that the electrode stacks (30, 30′) with their outer film (40, 40′) form a battery cell, the electrode stacks (30, 30′) via this film (40, 40′) being connected to the multi-chamber hollow profile (20).

4. The battery element according to claim 3, characterized in that the battery cell contains two elongated electrodes (31) and is enveloped by an outer film (40), this battery cell being wound around the flat multi-chamber hollow profile (20) and thereby bound to the multi-chamber hollow profile (20).

5. The battery element according to claim 1, characterized in that the thermally conductive contact between the electrode stack (30, 30′) or battery cell and multi-chamber hollow profile (20) is produced by an elastic clamping element.

6. The battery element according to claim 1, characterized in that there is a thermal connection of the electrode stack (30, 30′) to the multi-chamber profile (20), the thermal connection characterized by a thermal index
TK=ΣB_{K1-n}/(B_{E})
where each B_{K} is the width of a chamber of the multi-chamber hollow profile, and B_{E} is the width of the contact region of an electrode stack on the multi-chamber hollow profile,
the thermal index TK being greater than 0.8,
the battery element further characterized by a geometry factor
G=H_{B}/H,
where H_{B} is the body height of the battery cell and H is the height of the multi-chamber hollow profile 20,
the geometry factor G being in the range from 1.3 to 25.

7. The battery element according to claim 1, characterized in that the multi-chamber hollow profile (20) has an electrically insulating, thermoplastic plastic coating (27) on the outside.

8. The battery element according to claim 7, characterized in that the electrically insulating, thermoplastic plastic coating (27) of the multi-chamber hollow profile (20) is part of the insulation of the electrode stack (30, 30′) and the outer film (40, 40′) also forms part of the insulation.

9. The battery element according to claim 7, characterized in that an outer film (40) provided around an electrode stack (30) is welded to the thermoplastic plastic coating (27) of the multi-chamber hollow profile (20).

10. The battery element according to claim 1, characterized in that the multi-chamber hollow profile (20) is an extruded profile made of aluminum or an aluminum alloy and the upper broad side or the lower broad side of the flat multi-chamber hollow profile (20) contacts surfaces of one or more electrode stacks (30, 30′).

11. The battery element according to claim 9, characterized in that the outer film (40, 40′) which partially surrounds the electrode stack (30) is welded to the multi-chamber hollow profile (20) in the region of the longitudinal edges (23, 24), wherein the multi-chamber hollow profile (20) is wider than the electrode stack (30, 30′), namely the electrode stack (30, 30′) with its longitudinal edges (23, 24) protrudes and on the longitudinal edges (23, 24) of the multi-chamber hollow profile (20) no chambers (21) are provided.

12. The battery element according to claim 10, characterized in that the extruded multi-chamber hollow profile (20) has a height (H) of 0.3 to 10 mm.

13. The battery element according to claim 7, characterized in that the thermoplastic plastic coating (27) by a powder coating, a wet lacquer coating or as a film is applied to the surface of the multi-chamber hollow profile (20), the film being sealable.

14. The battery element according to claim 1, characterized in that to improve adhesion, the surface of the multi-chamber hollow profile (20) is chemically or mechanically pretreated.

15. The battery element according to claim 14, characterized in that the surface of the multi-chamber hollow profile (20) has been pretreated by anodizing or by conversion coating or by arc galvanizing or by a plasma treatment or by a laser treatment.

16. The battery element according to claim 1, characterized in that the chambers (21) of the multi-chamber hollow profile (20) with collector tubes (50) or connections (60) for a temperature control medium are connected, these connections with the collector tubes (50) or connections (60) on the end faces (28, 29) of the multi-chamber hollow profile (20) being outside the film (40, 40′).

17. The battery element according to claim 16, characterized in that the connection of the multi-chamber hollow profiles (20) to the collector tubes (50) or the connections (60) is carried out by means of soldering, in particular hard soldering.

18. The battery element according to claim 1, characterized in that a thermocouple is provided which is connected to a longitudinal edge (23, 24) of the multi-chamber hollow profile (20).

19. A battery module with a plurality of battery elements (10) according to claim 1, which are arranged side by side, preferably vertically, and with a distance (A) to a battery module, the distance (A) allowing thermal expansion without mutual contact of battery elements (10).

20. The battery module according to claim 19, characterized in that each battery element (10) in each case comprises connections on the end faces (28, 29) of the multi-chamber hollow profile (20), the battery elements (10) being held together via spacers (70).
